(19) United States
(12) Patent Application Publication
(10) Pub. No.: US 2017/0172315 A1
(43) Pub. Date: Jun. 22, 2017

(54) PRODUCT DISPLAY TRAY SYSTEM WITH SMART DIVIDERS AND MOTORIZED SMART DIVIDERS

(71) Applicant: Ronny Hay, Chatsworth, CA (US)

(72) Inventor: Ronny Hay, Chatsworth, CA (US)

(21) Appl. No.: 15/380,994

(22) Filed: Dec. 15, 2016

Related U.S. Application Data
(60) Provisional application No. 62/269,828, filed on Dec. 18, 2015.

(51) Int. Cl. A47F 1/12; A47F 10/02; G06Q 10/08; A47F 5/00

(52) U.S. Cl. CPC A47F 1/126; A47F 5/0025; A47F 5/005; A47F 10/02; G06Q 10/087; A47F 2010/025; A47F 2010/005

(57) ABSTRACT

Product display tray systems are provided and disclosed in which a vertical divider assembly or smart divider is used to create product row display areas and tray compartments and to detect the existence or nonexistence of products in the tray. Product compartments may be formed to hold products therein. Motorized smart dividers are also provided which contain mechanisms that automatically shift compartments or products forward after a product has been removed from the foremost position. Sensors are used to detect the presence or absence of products in order to activate the forward movement of the compartments or products and/or to provide information for sales and inventory reports.

### CROSS-REFERENCES TO RELATED APPLICATIONS

This application claims priority from U.S. Provisional Application No. 62/269,828, filed Dec. 18, 2015, which is incorporated by reference in its entirety.

### BACKGROUND

The present invention generally relates to methods and systems for displaying products on shelves and trays in a retail display cabinet using divider assemblies or “smart dividers”. More particularly, the present invention relates to a product display tray system that uses smart dividers to create product compartments in the tray, to detect the existence or non-existence of products on the tray using emitters and receivers in each smart divider and report such findings to the system's management network in real-time, and to automatically advance products forward within the tray using a motorized system as needed.

Traditional shelf displays do not have sensor mechanisms that detect when products are present or removed from the shelf, or a detection mechanism that allows the operator to monitor sales and inventory remotely. Also, the traditional shelf displays do not have a motorized, advance forward system as described in this invention.

The methods of displaying consumer goods are essential factors which affect sales volume and customer awareness. In many retail establishments, products are placed individually on shelves, or as bulk within a shared case. However, after the removal of the first few units from the front of the case, the remaining units are not always visible. This scenario is more critical when the products are on a lower shelf. More so, these limitations greatly affect products that are displayed on shelves or within cases that contain configured compartments that hold one unit each.

In many cases a pusher type display is used. Such pusher display contains a spring and a pusher element that push the products forward when the front items are removed. However, such pushing mechanism is not always suitable and may not work for every type of product.

Additionally, when the products that are placed in compartment trays have an expiration date, the person who fulfills the tray must first move the back units to the front of the tray and then fulfill the new units onto the back side of the tray. Such movement is necessary to avoid losses that are related to products with upcoming expiration dates. This extra step extends the fulfillment time and cost.

In addition to the limitations on product position, the traditional shelf displays do not have sensor mechanisms that detect when products are removed from the shelf, or a detection mechanism that allows the operator to monitor sales and inventory remotely.

Therefore, a need exists for a product display tray system including divider assemblies or smart dividers as described by this invention which detects the existence or non-existence of products in the tray and allows for monitoring of sales and inventory in real time. A need also exists for a product display tray system with smart dividers and a motorized system that can always position the products in the front of the tray, when desired. This invention fulfills these needs and provides other related advantages.

### SUMMARY OF THE INVENTION

The product display tray system of the present invention includes vertical divider assemblies or smart dividers in a physical tray and incorporates sensor technology to detect the existence or non-existence of products in the tray on the shelf of a retail display cabinet. In a preferred embodiment of the present invention, one or more pairs of vertical divider assemblies or smart dividers are arranged in the tray which incorporate infrared (IR) emitters and receivers to determine the existence or nonexistence of a product between each pair of dividers. When one smart divider's IR emitters emit IR light, the other smart divider's IR receivers detect the light if a product is absent between the smart dividers.

Each smart divider includes a centrally located printed circuit board, chip, or other electronic components which include the IR emitters and IR receivers. In a preferred embodiment of the present invention, each smart divider includes a printed circuit board (PCB) which includes the IR emitters on one side of the PCB and the IR receivers on the other side of the PCB. Thus, when the PCB is installed into the smart divider, the IR emitters emit light from one side of the smart divider, and the IR receivers receive light on the opposite side of the same smart divider. When a product is present between two smart dividers, the product obstructs the light emitting from a selected IR emitter to a selected IR receiver, and the receiver is in the dark. When the product is removed, the selected emitter's light is no longer obstructed and reaches the selected IR receiver, and the receiver reports this change to the system's management network.

Multiple pairs of smart dividers can be installed in one tray, and retail products can be displayed for sale between each pair of dividers. Each smart divider is also configured to accommodate the insertion of multiple horizontal dividers which create compartments between each pair of smart dividers.

The smart dividers of the present invention can be used to detect the existence or non-existence of products placed in compartments of a tray between two smart dividers as previously described, or to detect the existence or non-existence of products displayed between two smart dividers using a spring based pusher system in which a pusher element pushes each product forward in the tray as products are removed. The pusher concept is typically used to display canned and bottled drinks.

A motorized mechanism can also be incorporated in the present invention which advances products forward in the tray between each pair of smart dividers in response to commands from the system's management network.

The use of smart dividers allows for the recording of sales in real time as well as the managing of “on the shelf inventory” and fulfilment needs. The smart dividers are also nicely shaped, allowing for the appealing setup of products in the trays.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a perspective view of a product display tray system with smart dividers having emitters and receivers according to a first embodiment of the present invention, in which each pair of smart dividers creates a product row display area.

FIG. 2 is a front elevational view of a first smart divider from each pair of smart dividers referenced in FIG. 1 in the first embodiment, illustrating the placement of the emitters.

FIG. 3 is a rear elevational view of a second smart divider from each pair of smart dividers referenced in FIG. 1 in the first embodiment, illustrating the placement of the receivers.

FIG. 4 is a partial perspective view of the product tray display system with smart dividers of FIG. 1, illustrating the reconfigurable positioning capability of the smart dividers to create varied sizes of product row display areas.

FIG. 5 is a perspective view of the product tray display system with smart dividers of FIG. 1, in which multiple horizontal dividers are further incorporated which create multiple product compartments.

FIG. 6 is a perspective view of a horizontal divider referenced in FIG. 5.

FIG. 7 is a partial perspective view of the product tray display system with smart dividers and horizontal dividers of FIG. 5, illustrating the reconfigurable positioning capability of the smart dividers and horizontal dividers to create varied sizes of individual product compartments.

FIG. 8 is a perspective view of a product tray display system with smart dividers including emitters and receivers according to a second embodiment of the present invention, including a pusher mechanism which advances products forward along a track between each pair of smart dividers in the tray.

FIG. 9 is a perspective view of the product tray display system with smart dividers of FIG. 8, illustrating products advancing forward in the product row display areas of the tray.

FIG. 10 is a perspective view of the track referenced in FIG. 8 along which the products are pushed forward in the tray.

FIG. 11 is a front elevational view of a first smart divider from each pair of smart dividers referenced in FIG. 8 in the second embodiment, illustrating the placement of the emitters.

FIG. 12 is a rear elevational view of a second smart divider from each pair of smart dividers referenced in FIG. 8 in the second embodiment, illustrating the placement of the receivers.

FIG. 13 is a perspective view of a product display tray system with motorized smart dividers including emitters and receivers according to a third embodiment of the present invention.

FIG. 14 is a front elevational view of a first smart divider of the motorized smart dividers referenced in FIG. 13 in the third embodiment, illustrating the placement of the emitters.

FIG. 15 is a rear elevational view of a second smart divider of the motorized smart dividers referenced in FIG. 13 in the third embodiment, illustrating the placement of the receivers.

FIG. 16 is a partial perspective view of the product display tray system with motorized smart dividers of FIG. 13, illustrating the placement of a horizontal divider assembly.

FIG. 17 is a partial perspective view of the product display tray system with motorized smart dividers of FIG. 13, illustrating the placement of a motor for moving the horizontal divider assembly towards the front of the tray.

FIG. 18 is a perspective view of the horizontal divider assembly referenced in FIG. 16 in its extended configuration.

FIG. 19 is a perspective view of the horizontal divider assembly referenced in FIG. 16 in its retracted configuration.

FIG. 20 is a partial perspective view of the product display tray system with motorized smart dividers of FIG. 13, illustrating the placement of multiple horizontal divider assemblies which create individual product compartments.

FIG. 21 is a front perspective view of a product display tray system with motorized smart dividers including emitters and receivers according to a fourth embodiment of the present invention.

FIG. 22 is a rear perspective view of the product display tray system with motorized smart dividers of FIG. 21 in the fourth embodiment.

FIG. 23 is a partial rear perspective view of the product display tray system with motorized smart dividers of FIG. 21 in the fourth embodiment, illustrating the placement of horizontal divider assemblies.

FIG. 24 is a partially exploded perspective view of the product display tray system with motorized smart dividers of FIG. 21, illustrating the placement of the motor for the smart dividers.

FIG. 25 is an alternate, partially exploded perspective view of the product display tray system with motorized smart dividers of FIG. 21.

FIG. 26 is a partial perspective view of the product display tray system with motorized smart dividers illustrated in FIG. 25.

FIG. 27 is a partial perspective view of the product display tray system with motorized smart dividers of FIG. 21, illustrating placement of the rails which support the horizontal divider assemblies.

FIG. 28 is an enlarged, partially exploded partial perspective view of the product display tray system of FIG. 21 with horizontal divider assemblies.

FIG. 29 is a perspective view of a horizontal divider assembly referenced in FIG. 28.

FIG. 30 is a partial perspective view of the horizontal divider assembly with its flaps removed for clarity.

FIG. 31 is a perspective view of a product display tray system with smart dividers according to a fifth embodiment of the present invention, including a pusher mechanism for advancing products forward in the tray.

FIG. 32 is a partial perspective view of the product display tray system with smart dividers in the fifth embodiment.

FIG. 33 is a rear perspective view of the product display tray system with smart dividers of FIG. 31.

### DETAILED DESCRIPTION OF THE PREFERRED EMBODIMENTS

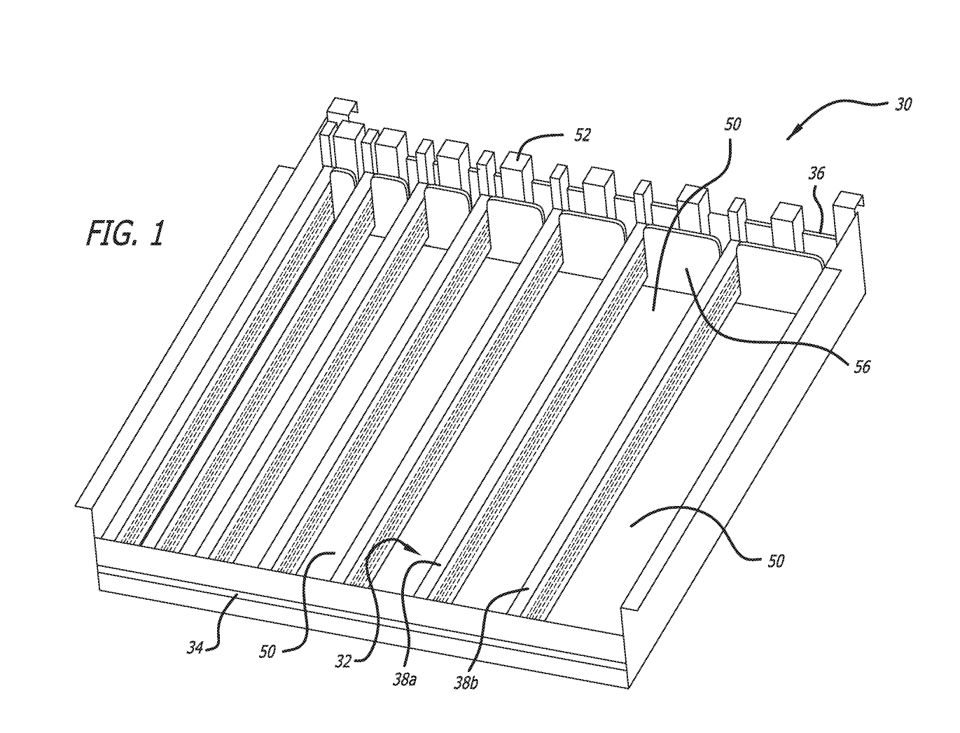

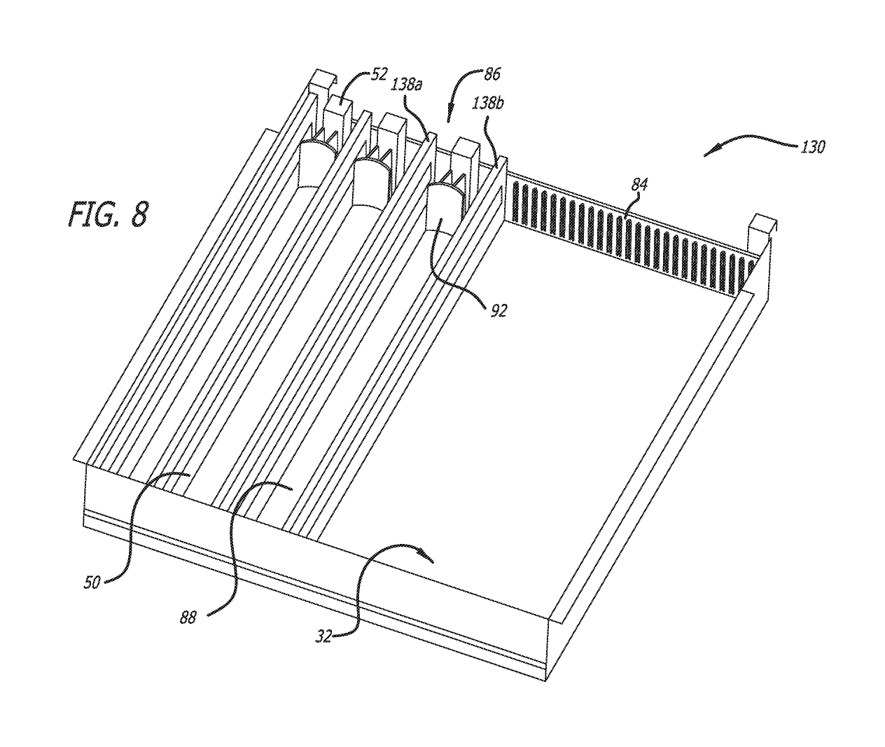

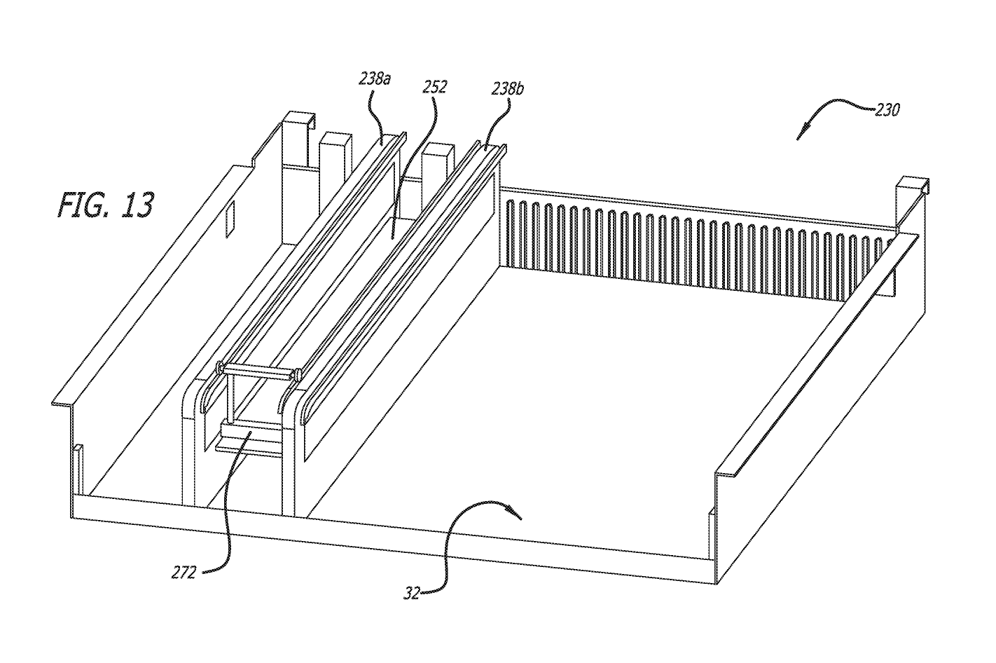

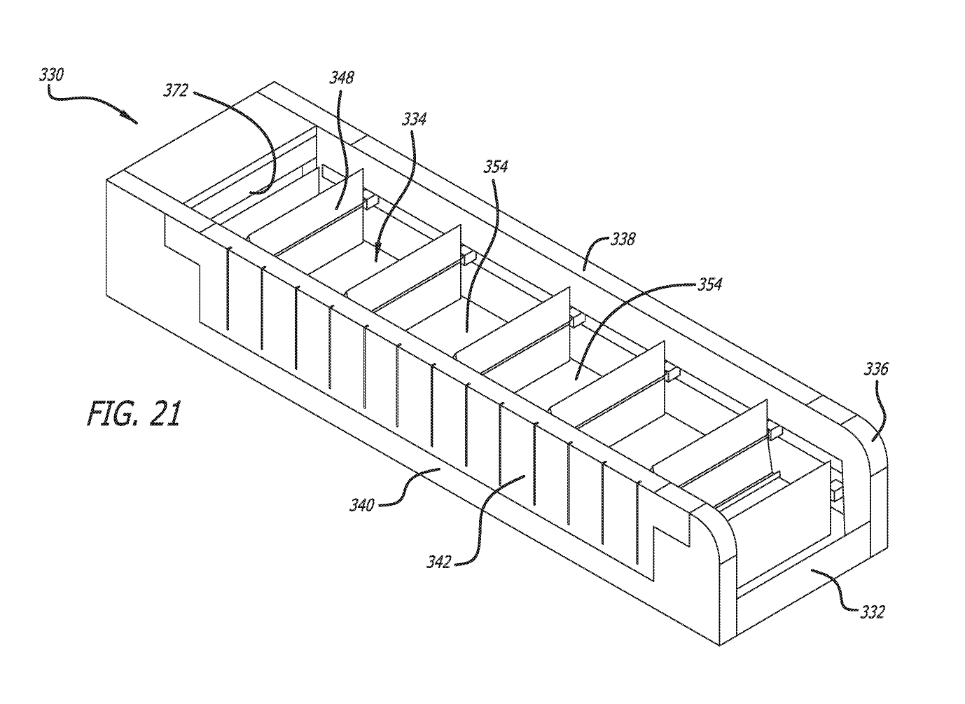

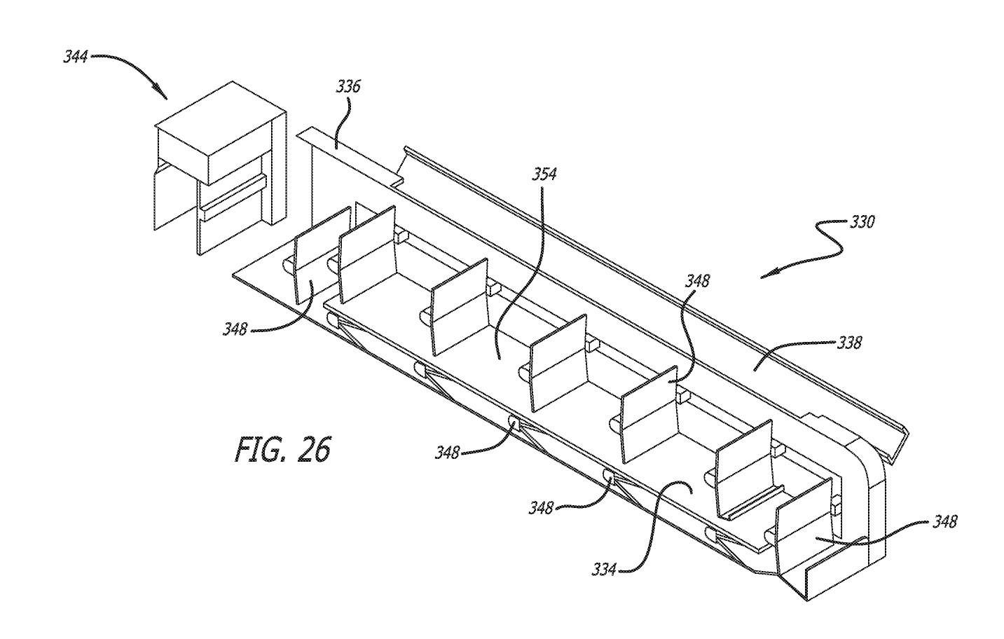

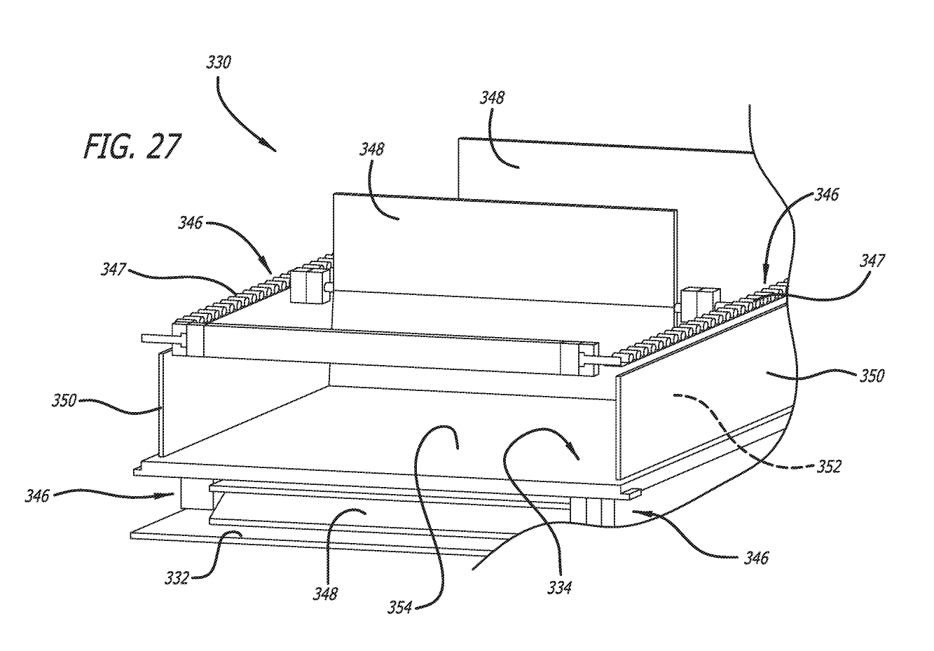

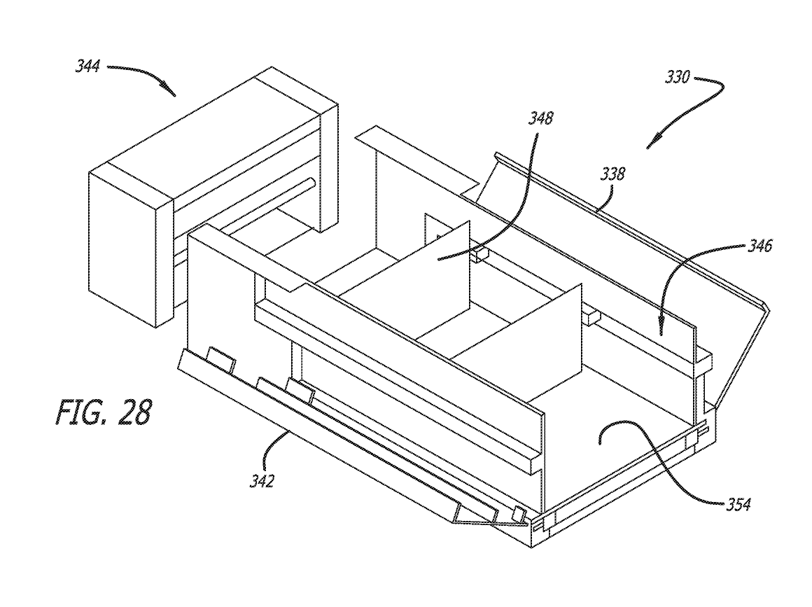

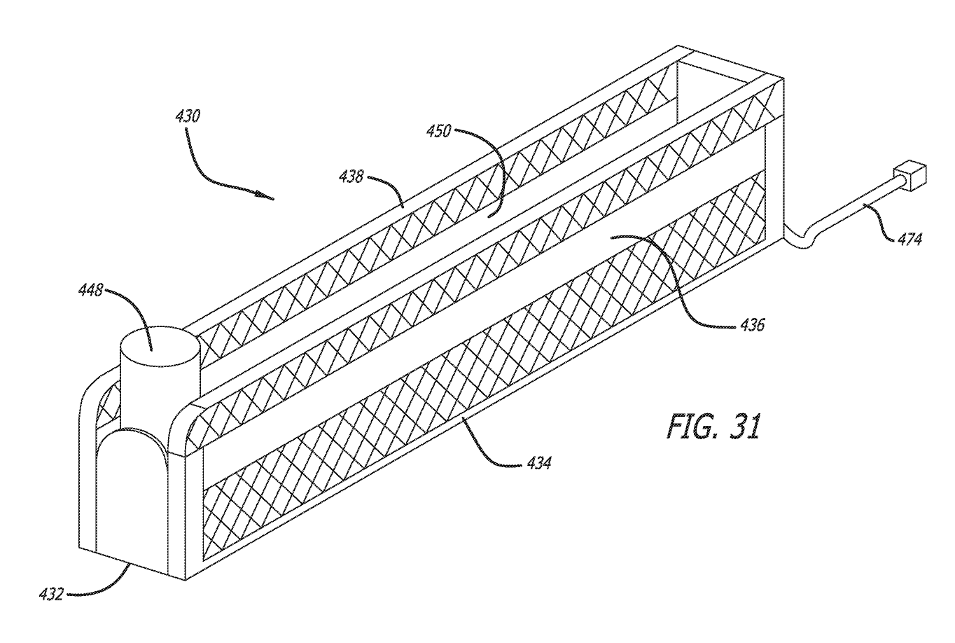

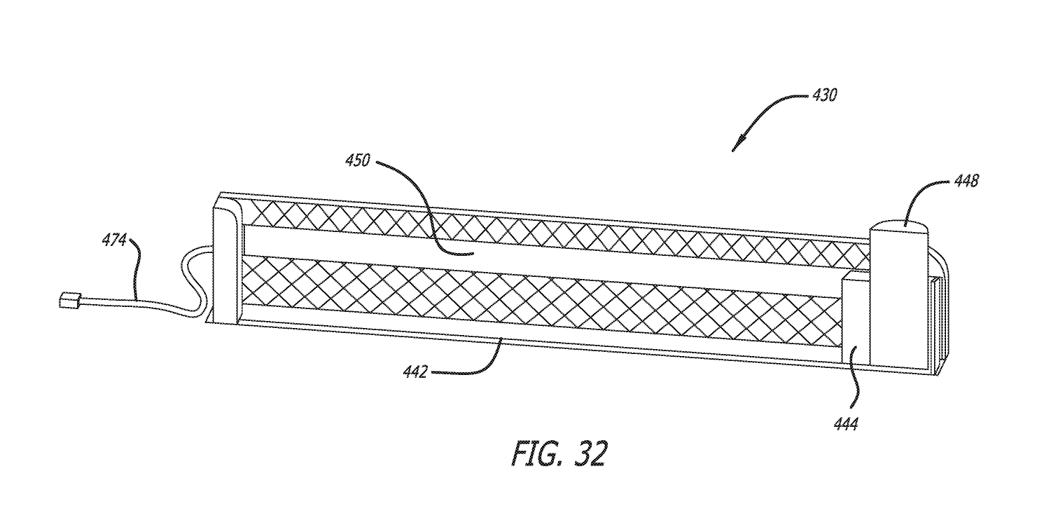

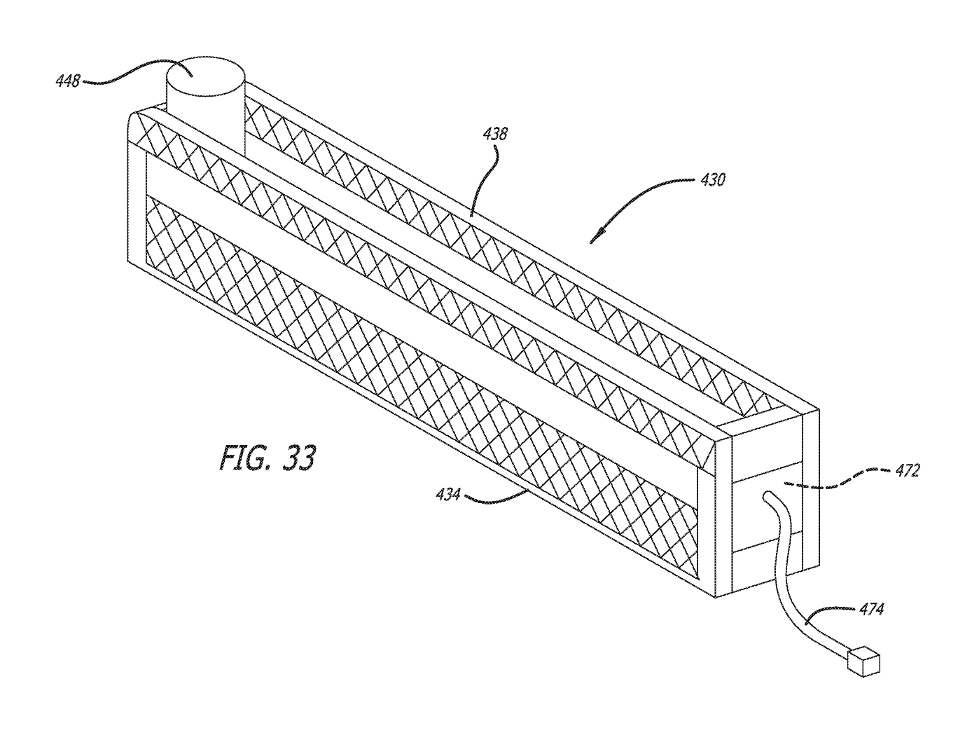

As shown in the accompanying drawings, for purposes of illustration, the present invention relates to several embodiments of a product display tray system or product display assembly system 30, 130, 230, 330, and 430, in which FIGS. 1-7 relate to the first embodiment, FIGS. 8-12 relate to the second embodiment, FIGS. 13-20 relate to the third embodiment, FIGS. 21-30 relate to the fourth embodiment, and FIGS. 31-33 relate to the fifth embodiment.

Referring to FIGS. 1-7, a first embodiment of the product tray assembly system 30 of the present invention includes a tray base 32 having a front bridge or front side 34 and a back bridge or back side 36. The front and back sides are used to physically engage and secure identical vertical divider assemblies or smart dividers, referenced in pairs by numbers 38a and 38b, onto the surface of the product display tray base 32. The smart dividers can be installed into the tray base 32 at different distances from each other to accommodate the display of different sized products in product row display areas 50.

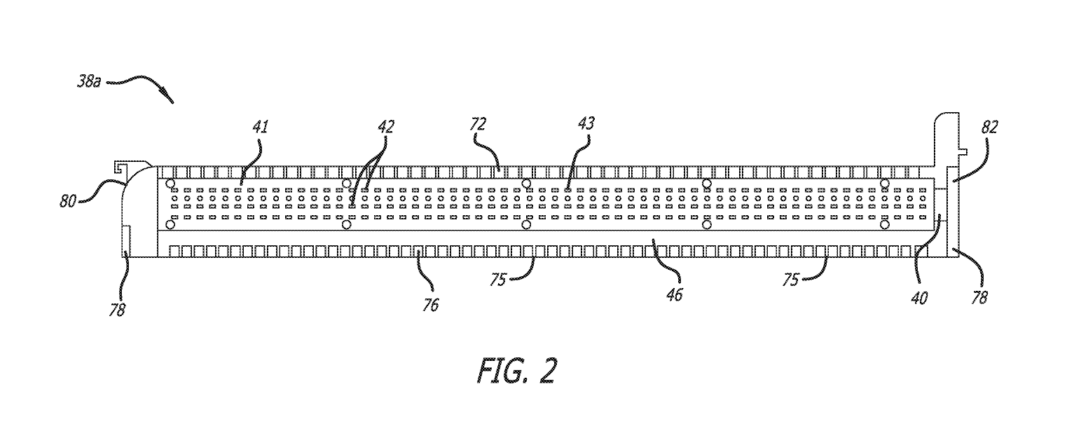

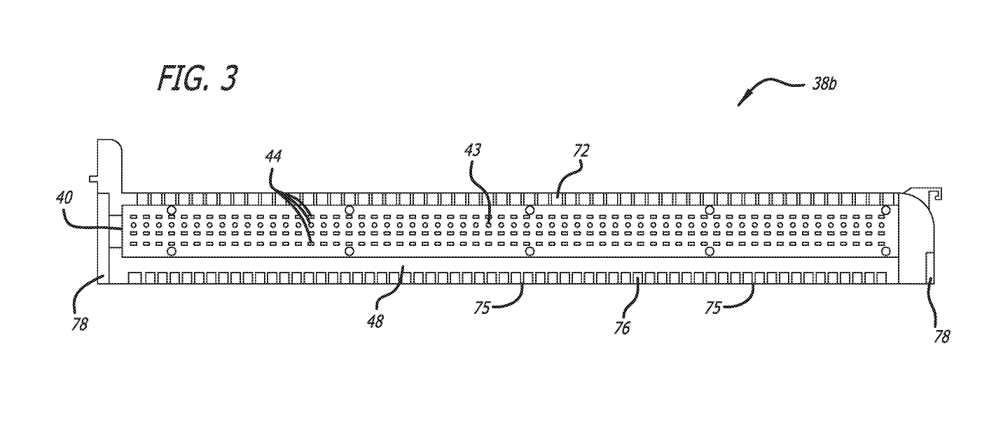

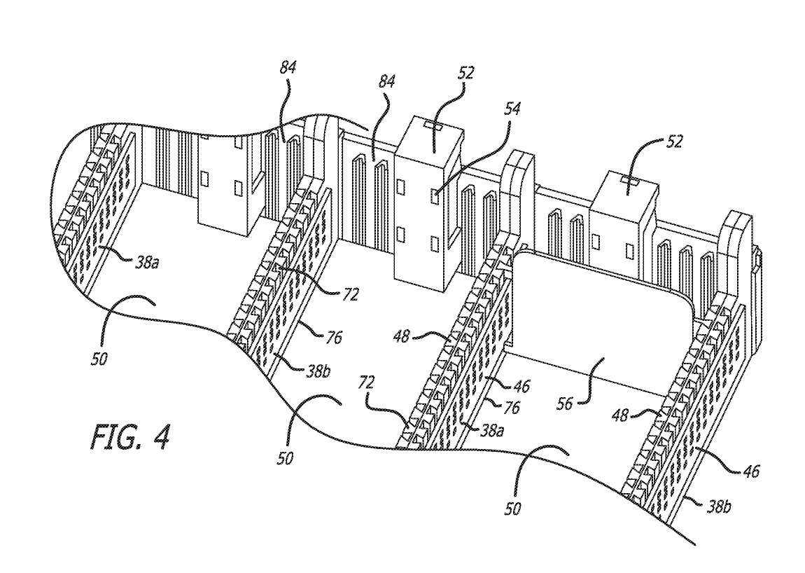

A divider PCB 40 is installed in a recess (not shown) of each smart divider 38a and 38b (see FIGS. 2 and 3, respectively), and the PCB is enclosed by a cover 41 fastened to one side of the smart divider. Each PCB 40 in each smart divider 38a, 38b contains sensors such as IR emitters 42 on one side 46 of the PCB (see FIG. 2), and sensors such as IR receivers 44 on the other side 48 of the PCB (see FIG. 3). Each smart divider also includes corresponding apertures 43 on both of its sides which are aligned with the emitters 42 and receivers 44. When the smart dividers 38a and 38b are placed in pairs inside the product display tray assembly system 30 as shown in FIG. 4, the emitters 42 on one side 46 of the first smart divider 38a face and align with the receivers 44 on the other side 48 of the second smart divider 38b, on a one-by-one basis. Based on this unique set-up, a single divider 38a, 38b can be used for two product row display areas 50, thus saving space in the tray base 32 and eliminating the cost that a secondary divider would incur.

As illustrated in FIG. 4, a PCB box 52 is positioned at the back of the tray base 32 between each pair of smart dividers 38a, 38b which contains a controller 54 for the tray including one or more chips, PCBs, or other electronic components. The controller 54 is connected by wire or wirelessly to the system's management network (not shown) as well as to the PCB 40 of each smart divider 38a and 38b. The controller thus manages the communication between the smart dividers and the system's management network.

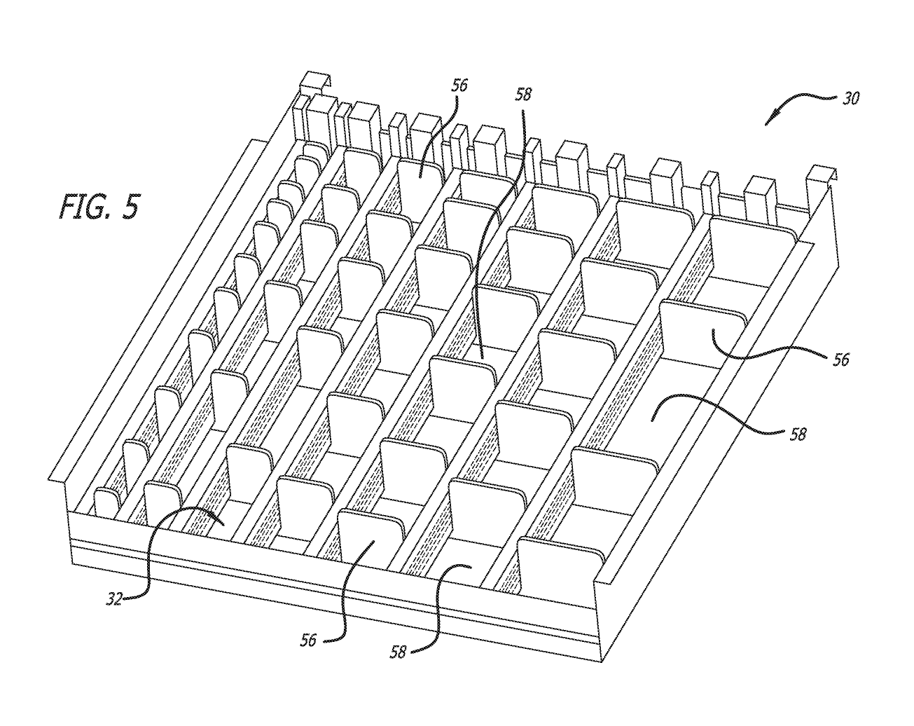

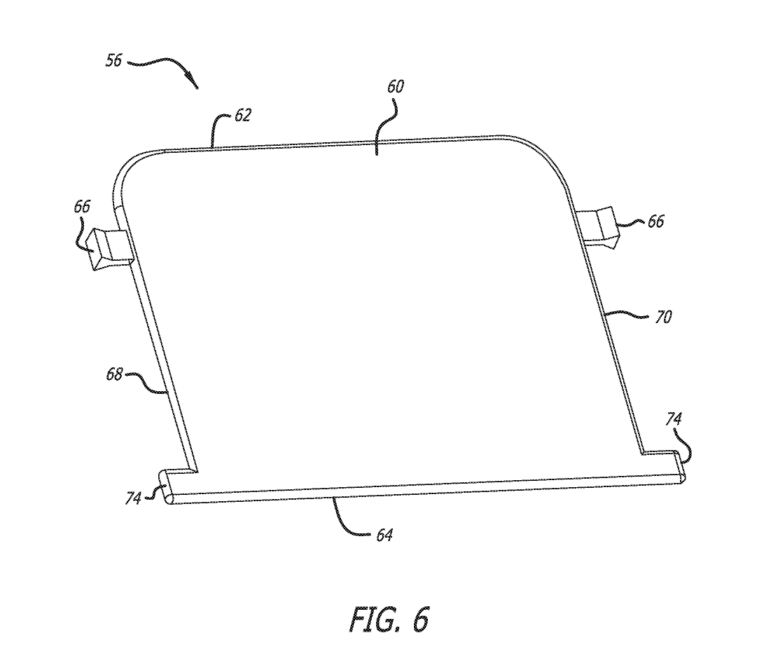

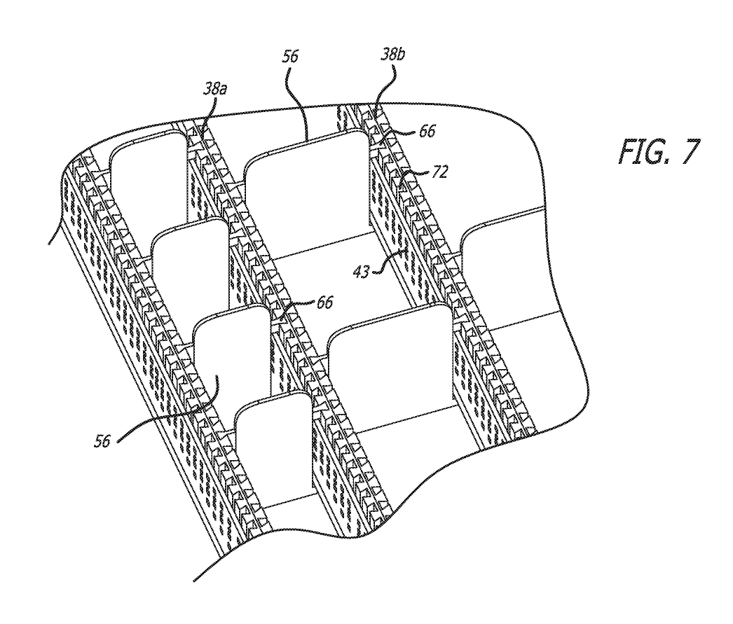

Referring to FIGS. 5 and 6, different sized horizontal dividers 56 may be placed between two smart dividers 38a, 38b to create individual product compartments 58. Each horizontal divider includes a body 60, a top side 62 which may be rounded, and a bottom side 64. Dovetail hooks 66 or other fasteners are attached or connected to left and right sides 68, 70 of each horizontal divider and are configured to correspondingly and selectively mate with dovetail depressions 72 or other fasteners (see FIG. 7) integrated into the top side of each smart divider 38a, 38b. Moreover, projections 74 extend from the bottom side of the body 60 on its left and right sides 68, 70, which are sized to be selectively received in corresponding recesses 75 integrated into the bottom side of each smart divider 38a, 38b (as illustrated in FIGS. 2 and 3). These recesses 75 are disposed between areas 76 aligned with the apertures 43 on each side of the smart divider, and these areas 76 can in turn be used to display indicia (not shown) thereon for individually identifying sensors 42 and 44. Each smart divider also includes divider projections 78 (see FIG. 2) on opposite ends 80, 82 of each smart divider which are sized to be selectively received in corresponding tray recesses 84 (see FIG. 4) integrated into the front and back sides of the tray base 32. In this way, the horizontal dividers and smart dividers can be positioned and supported in various locations of the tray base 32 to form variously sized compartments 58 as desired.

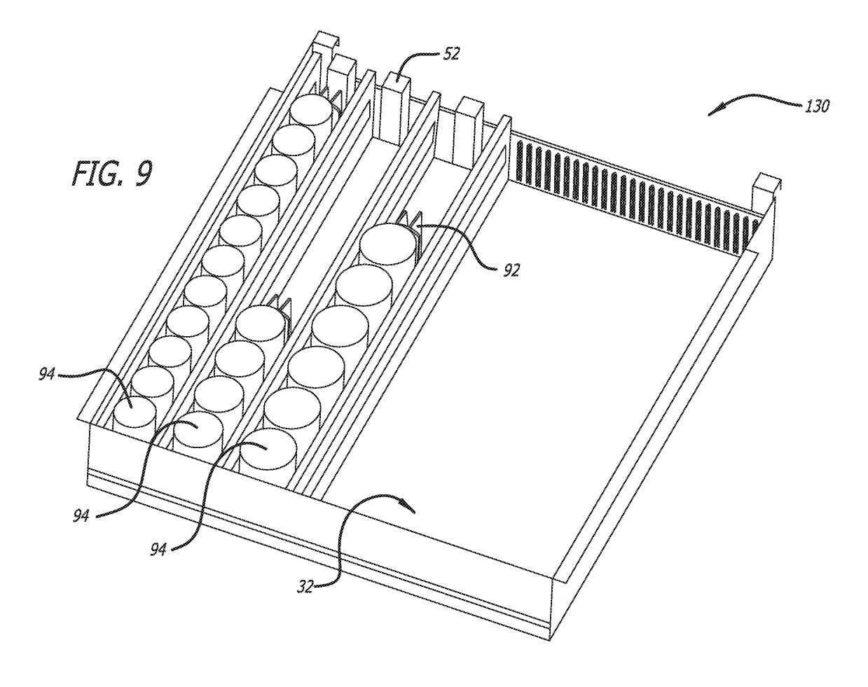

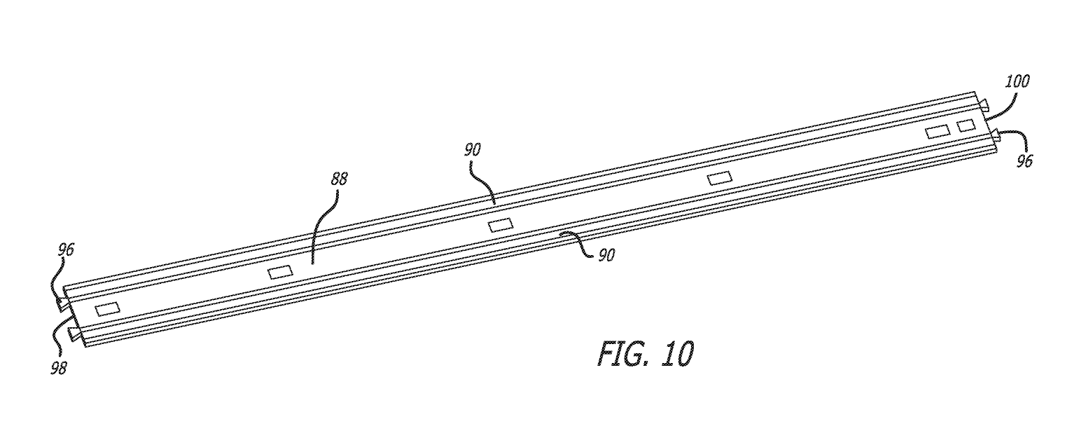

Referring now to FIGS. 8-12, in a second embodiment of a tray assembly system 130, a pusher mechanism 86 can be placed in between pairs of smart dividers 138a, 138b for the sale of canned and bottled drinks as well as other suitable products. Each pusher mechanism 86 includes a track 88 with grooves 90 (see FIG. 10), a pusher 92 (see FIGS. 8 and 9) configured to be slidably attached to the track to advance products forward along the grooves 90, and a spring (not shown) within the pusher. The spring is in a compressed state when beverages or other products 94 are present on the track. When a beverage is removed from the front of the tray base 32, the compression of the spring is relieved causing the pusher to move the remaining products 94 forward towards the front of the tray base as shown in FIG. 9. Each track also includes track projections 96 on opposite ends 98, 100 of the track which are sized to be received in the corresponding tray recesses 84 integrated into the front and back sides of the tray 32, thereby allowing the position of the tracks as well as the smart dividers to be customized as desired.

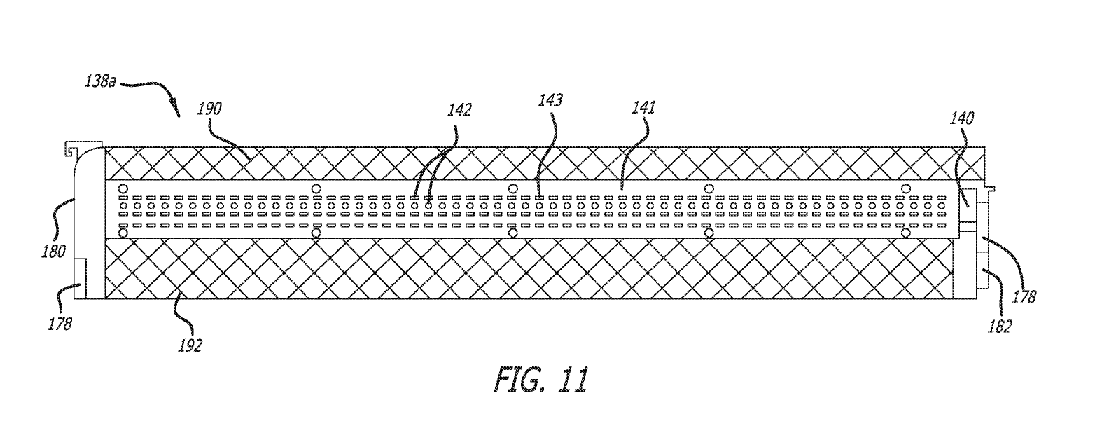

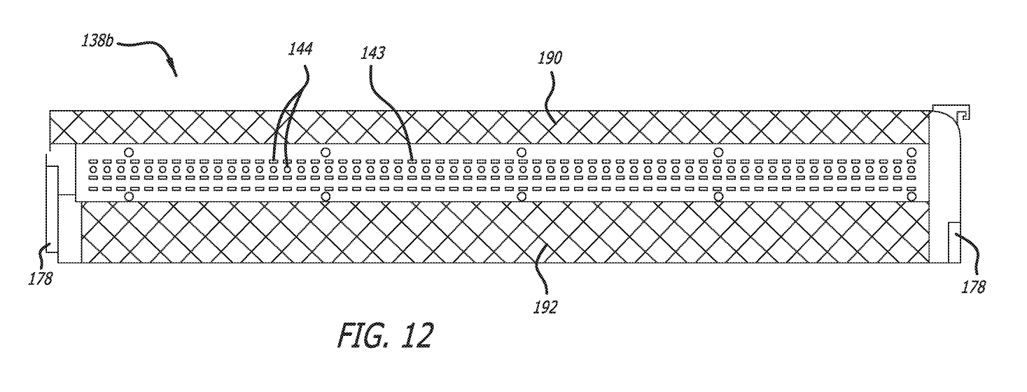

As illustrated in FIGS. 11 and 12, the vertical divider assemblies or smart dividers 138a, 138b used with the pusher mechanism 86 are essentially identical to smart dividers 38a, 38b in that they identically include a divider PCB 140 in communication with the controller 54, a cover 141 on one side which encloses the divider PCB 140, sensors such as emitters 142 and receivers 144 on opposite sides of the divider PCB and smart divider, apertures 143 aligned with the emitters and receivers, and divider projections 178 on opposite ends 180, 182 of the smart divider which are sized to be selectively received in tray recesses 84. However, the smart divider 138a, 138b includes a cross-grid top 190 and bottom 192 which provide greater height to the smart divider.

After the product display tray assembly system 30, 130 is set up with one or more pairs of vertical divider assemblies or smart dividers 38a, 38b, 138a, 138b, horizontal dividers 56 as desired, optional pusher mechanisms 86, and PCB boxes 52, and once the product display tray assembly system is integrated with the system's management network, the product display tray assembly system is ready to be used. Products can be placed in compartments 58 between smart dividers, or over the sliding base or track 88 of the pusher mechanism 86. The system is then programmed to activate selected emitters 42, 142 and receivers 44, 144 to determine if products are present in individual compartments as will be subsequently described.

With respect to the first embodiment, when the system 30 is in a ready mode and a product is disposed in a compartment 58, the product obstructs the receiver 44 assigned to the compartment 58 such that the receiver does not receive light from the corresponding emitter 42, and the system's management network therefore considers that product to be present within that compartment. When the product is removed from that compartment, the receiver 44 detects the light and reports the change to the system's management network as a product removal via the controller 54.

With respect to the second embodiment of the system 130 where a pusher mechanism 86 is used, the system's management network similarly considers a product to be present when the receiver 144 is obstructed. However, when a product is removed and the pusher 92 consequently slides forward, the receiver 144 behind the last present product 94 in the row is no longer obstructed and subsequently detects light from the corresponding emitter 142. This detection is similarly reported to the system's management network via the controller 54, and the system management network therefore considers the product to not be present.

Each row between two smart dividers 38a, 38b, 138a, 138b is considered to be the product's row display area 50. The controller 54 is configured to selectively activate or deactivate one or more sensors in each smart divider associated with a product row display area in accordance with various programmable modes, including a ready mode, a fulfillment or restocking mode, and a quarantine mode. For example, when a product's row display area is in ready mode, selected IR emitters 42, 142 and IR receivers 44, 144 are activated and programmed accordingly and ready to report changes in light detection. In restocking mode, all IR emitters and receivers are inactive, allowing for the tray base 32 to be filled with fresh products. In quarantine mode, only some IR emitters and some IR receivers are activated while others are rendered inactive for a certain time. The quarantine mode may be used for instance where one or more of the emitters and receivers are determined to be defective, where the products in a product row display area are determined to be expired and need to be replaced, or other situations necessitating deactivation of the emitters and receivers associated with particular product row display areas, Other modes may also be created as needed.

The smart dividers of the present invention have been designed to fit well into the product display tray assembly system 30, 130 while allowing a horizontal line of sight to exist between each individual emitter and receiver of the pair of smart dividers 38a, 38b, 138a, 138b, on a one-by-one basis. Each emitter and receiver is recessed into the smart divider body to avoid light leakage and misreading. The dual-sided PCB 40, 140 is designed to maximize the product row display area of the tray and reduce the number of smart dividers needed. Such special designs provide the ultimate tray configuration and the highest detection accuracy.

Although the preferred embodiments of the present invention incorporate IR emitters and IR receivers to detect the existence or non-existence of products between pairs of smart dividers, such detection may also be accomplished by using any other type of light, any optical, electrical, or mechanical system, or any system that detects electromagnetic frequencies, including radio frequencies, such as RFID, NFC and the like.

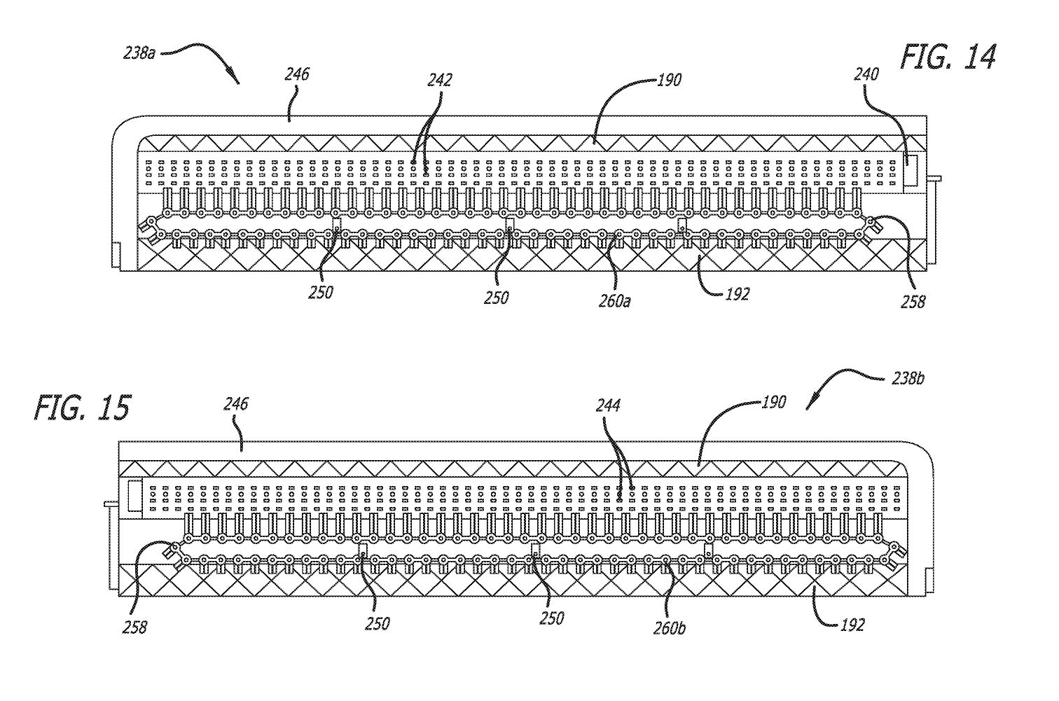

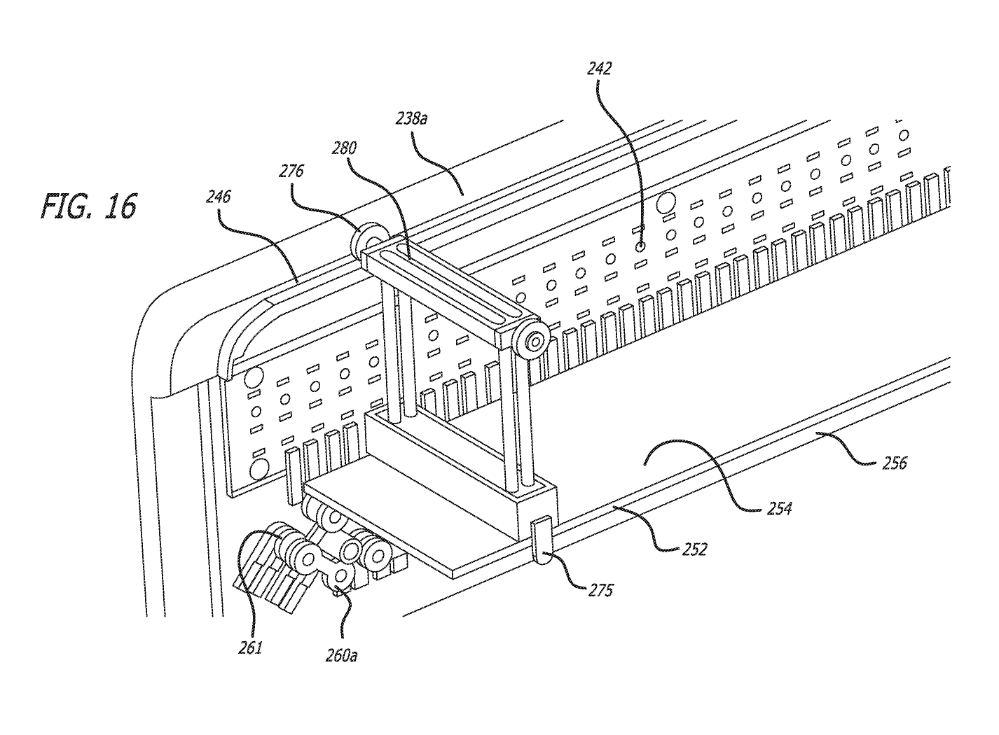

Referring now to FIGS. 13-20, in a third embodiment of the product tray assembly system 230, a tray base 32 with motorized smart dividers 238a, 238b is provided. The smart dividers 238a, 238b illustrated in FIGS. 14 and 15 are substantially identical to smart dividers 138a, 138b, including a PCB 240 with IR emitters 242 and IR receivers 244 on opposite sides of the PCB which detect the existence or non-existence of products on the tray base as previously described. However, in this embodiment, each smart divider 238a, 238b includes a track 246 disposed along the top surface of each smart divider (see FIG. 16) to support the motorized feature subsequently described.

The system 230 of the present invention in this embodiment includes smart dividers 238a, 238b with sensors, as well as electrical and mechanical mechanisms which cooperatively advance products to a front position of the tray or shelf. The presence or removal of products from the motorized smart dividers tray base 32 is detected using sensors in the smart dividers 238a, 238b to monitor sales and inventory and to advance products forward within the tray base 32. Such sensors can be infrared emitters 242 and receivers 244 as in the preferred embodiments, or can be other optical, electrical, or mechanical sensors, or detect electromagnetic frequencies, including radio frequencies, such as RFID, NFC and the like.

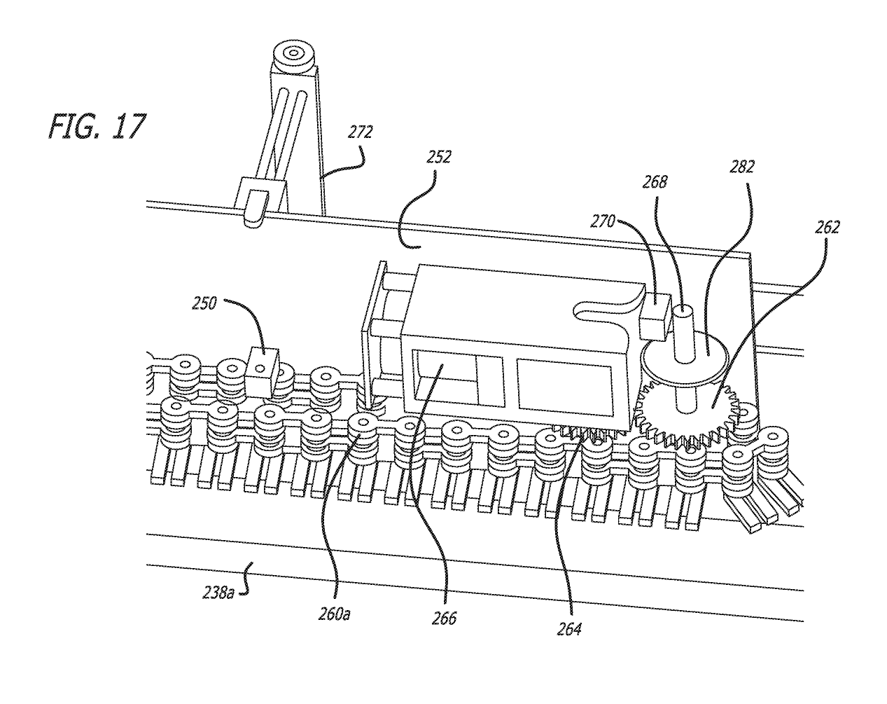

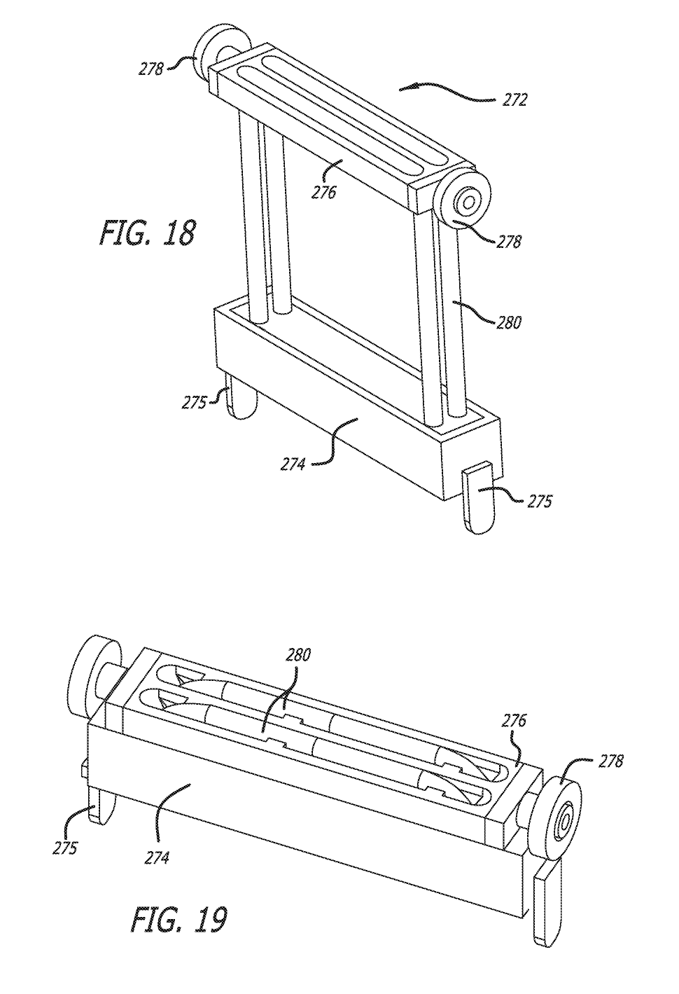

As illustrated in FIGS. 14-17, the product tray assembly system 230 with motorized smart dividers includes a pair of vertical divider assemblies or smart dividers 238a, 238b, and a motorized mechanism including one or more counting sensors 250 attached to each side of each smart divider, a base or product platform 252 disposed between the pair of smart dividers 238a, 238b and having a top surface 254 and a bottom surface 256, mounting support elements 258 attached to the smart dividers, two closed chains 260a, 260b with chain links 261 attached to each side of smart dividers 238a, 238b, sprockets 262 (see FIG. 17), middle supporting gears 264, a motor 266, a driving shaft 268, a counting sensor unit 270, one or more horizontal divider assemblies 272 disposed along the product platform 252, and other inclusive parts and elements. As shown in FIGS. 18 and 19, each horizontal divider assembly 272 includes a divider base 274 with anchor pillars 275, an upper bar 276, side wheels 278, elastic bungees 280, and a spring (not shown).

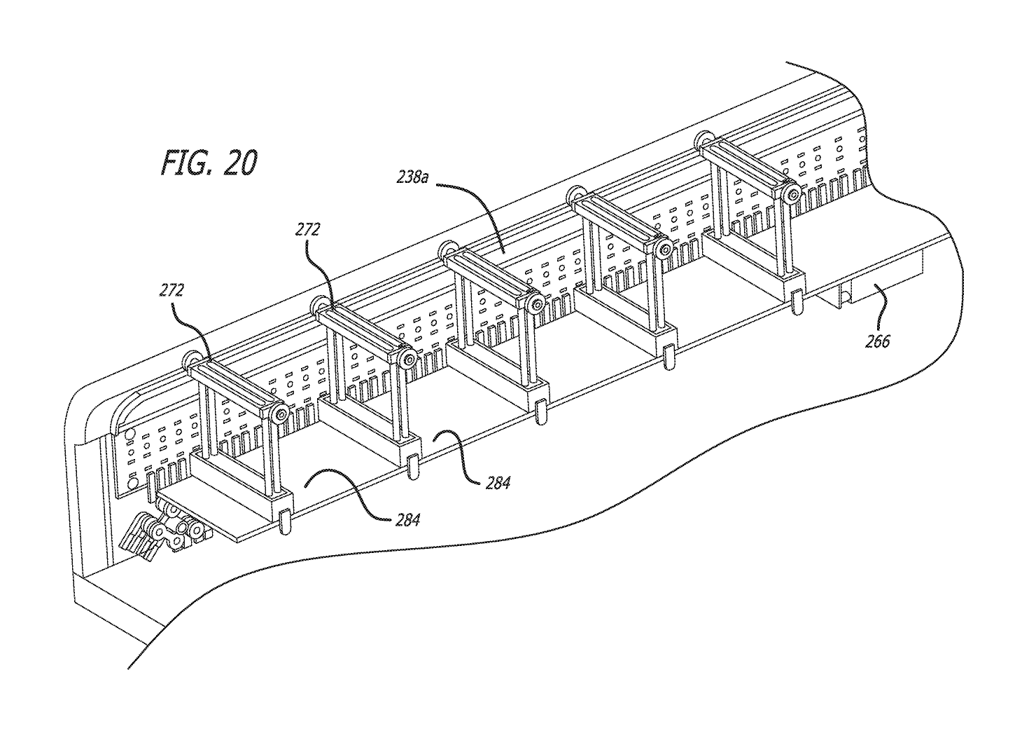

The smart dividers 238a, 238b serve as the side panels of the tray base 32 and support the base or product platform 252, the sprockets 262 and the middle supporting gears 264. The closed chains 260a, 260b are assembled over the sprockets 262 and the middle supporting gears 264. The chain links 261 are configured to hold the anchor pillars 275 of the horizontal divider assembly 272 to move the horizontal divider assembly along the product platform to the front of the tray base 32. The base or product platform 252 is configured to support products on its upper surface 254, and the motor 266 is supported under the bottom surface 256 of the product platform. The driving shaft 268 is assembled into the sprockets 262 and it is rotated by the motor 266. A perforated wheel 282 on the driving shaft 268 is configured to swing through the counting sensor unit 270 so that, together with information delivered from the smart dividers' counting sensors 250, the system will be able to determine the number of compartments 284 (see FIG. 20) assembled in the tray and the distance between the compartments.

The product tray assembly system 230 is configured to display consumer products within the compartments 284 and to move the compartments forward in response to detection by the smart dividers' sensors 242, 244 of removed products. The compartments are created by installing multiple horizontal divider assemblies 272 along the upper surface 254 of the base or product platform 252. Parts of the system 230 can be sized narrower or wider to accommodate different size products, and the compartments can be sized to fit the thickness of each product.

The horizontal divider assemblies 272 are used to create product compartments 284 along the upper surface 254 of the base or product platform 252. After placing a product on the upper surface of the base 252, a divider assembly 272 is placed behind each product and the anchor pillars 275 of the dividers assemblies are inserted into the links 261 of the chain 260a, 260b below. The upper bar 276 of the horizontal divider assembly is pulled up manually into its extended configuration (see FIG. 18), and the side wheels 278 of the horizontal divider assembly are placed on the tracks 246 of each smart divider. When the horizontal divider assembly 272 reaches the front of the tray base 32, the side wheels 278 exit the tracks 246 and the elastic bungees 280 of the divider assembly force the upper bar 276 down over the divider base 274 (see FIG. 19). Folded divider assemblies in their retracted configuration travel to the back of the tray base 32 under the product platform 252, until the next product fulfilment when the upper bar 276 has been pulled up manually again.

In an alternative embodiment of the product display tray system as illustrated in FIGS. 21-30, the motorized tray may be used with a timing belt and folding dividers as described hereafter. In this fourth embodiment, the motorized product display tray with sensor system (MT) or product display assembly system 330 generally comprises a base 332, a product platform 334, a right-side vertical divider assembly or smart divider 336, a right side panel cover 338, a left side vertical divider assembly or smart divider 340, a left side panel cover 342, a motorized mechanism including motor & gears assembly 344 and belts 346 including pin barrels 347, a horizontal divider assembly 348 and other inclusive parts and elements. Each smart divider 336 and 340 contains a double-sided PCB 350 with emitters 352 on one side and receivers (not shown) on the other side for a row display area, and circular apertures (not shown) through which light from the emitters can pass to the receivers.

The MT 330 is configured to display consumer products within compartments 354 and to move the compartments forward in the tray base 332 in response to removal of a product from the compartment. The compartments are created by installing multiple horizontal divider assemblies 348 over the product platform 334 of the MT. Trays can be sized narrower or wider and each compartment can be sized to fit the thickness or width of each product.

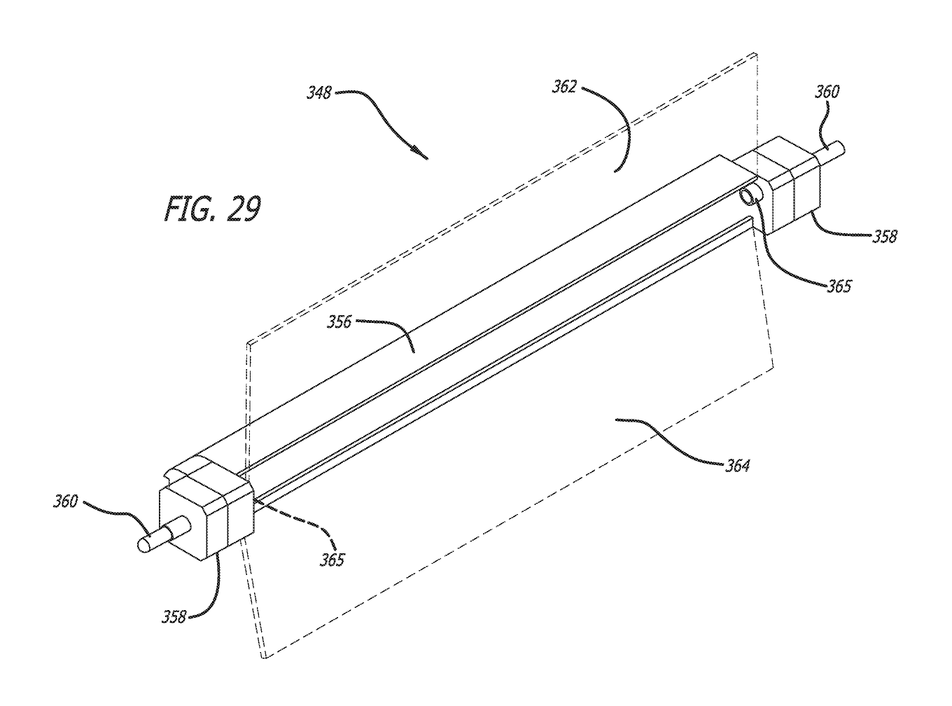

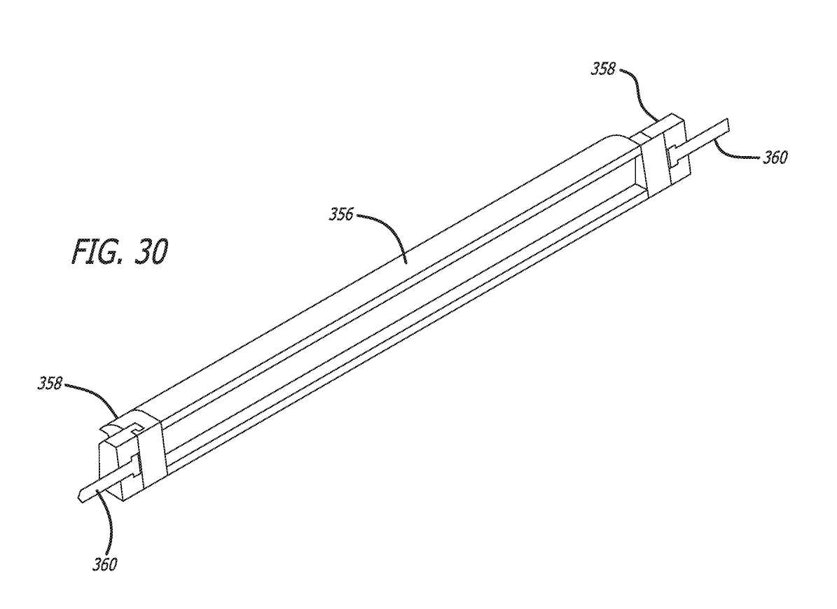

With reference to FIGS. 29 and 30, each horizontal divider assembly 348 comprises a main joist 356, two side holders 358, two side pins 360, a top flap 362, a bottom flap 364 and springs 365. In order to create a compartment 354, the right and left side pins 360 are inserted into the selected pin barrel 347 of the belt 346, on both sides of the tray base 332. Selection of the pin-barrel 347 configures the distance between each horizontal divider assembly 348, which allows flexibility in creating and adjusting the length or size of the compartment 354 between adjacent horizontal divider assemblies 348.

Each vertical divider assembly or smart divider 336, 340 is configured to hold belts 346, as well as gears (not shown), spindles (not shown) and the PCBs 350. The PCBs may include optical emitters (such as Infrared emitters) 352 on one side and receivers (not shown) on the other side, or alternatively, may include RFID/NFC type detectors. It will be appreciated that these are merely examples of preferred sensors or means of detecting the presence of a product within a particular compartment 354 or location within the tray base 332, and that other mechanisms or sensors for detecting the presence or absence of the product can be incorporated.

The product platform 334 is assembled above the tray base 332 and between the smart dividers 336 and 340. Each product is placed on top of the product platform 334 in a compartment 354 between two divider assemblies 348.

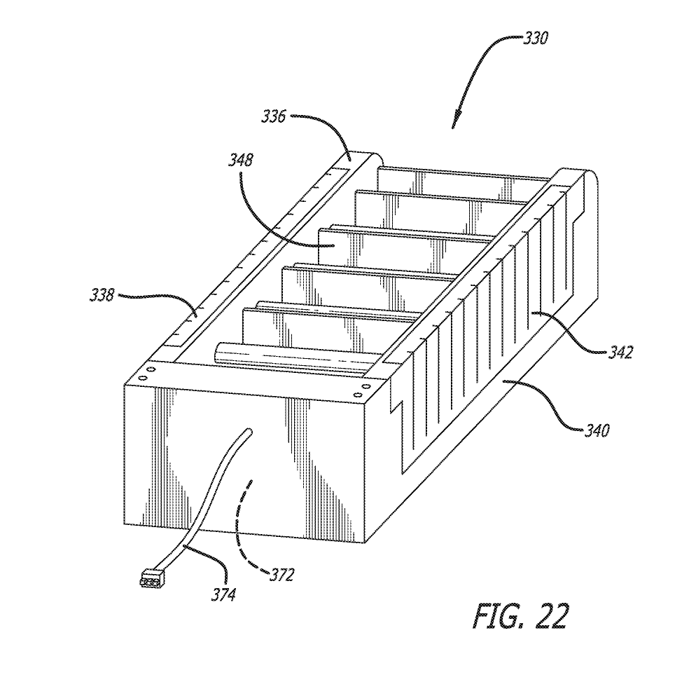

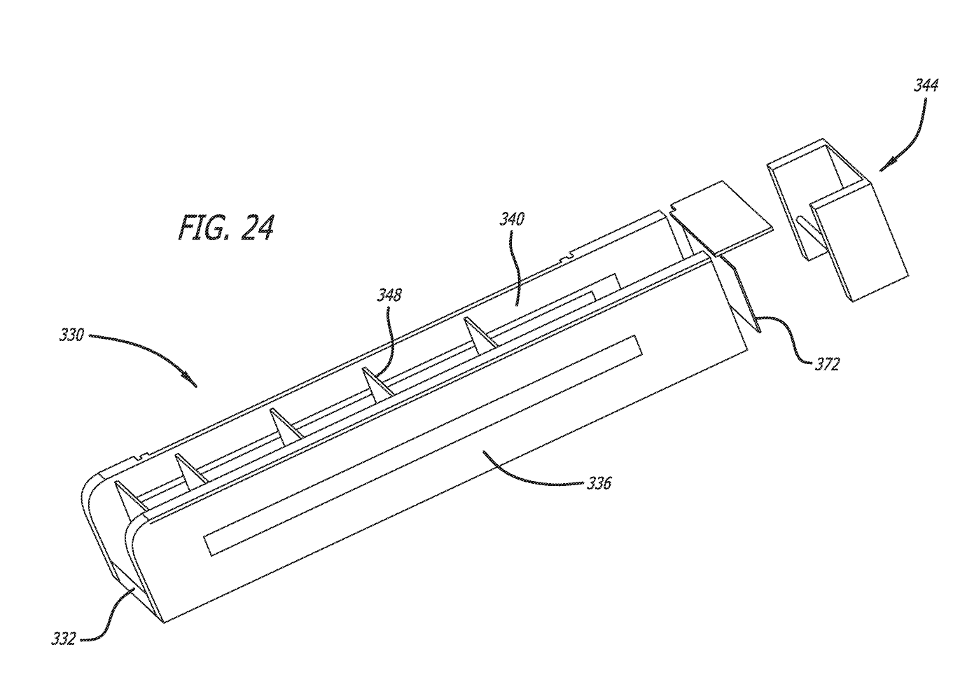

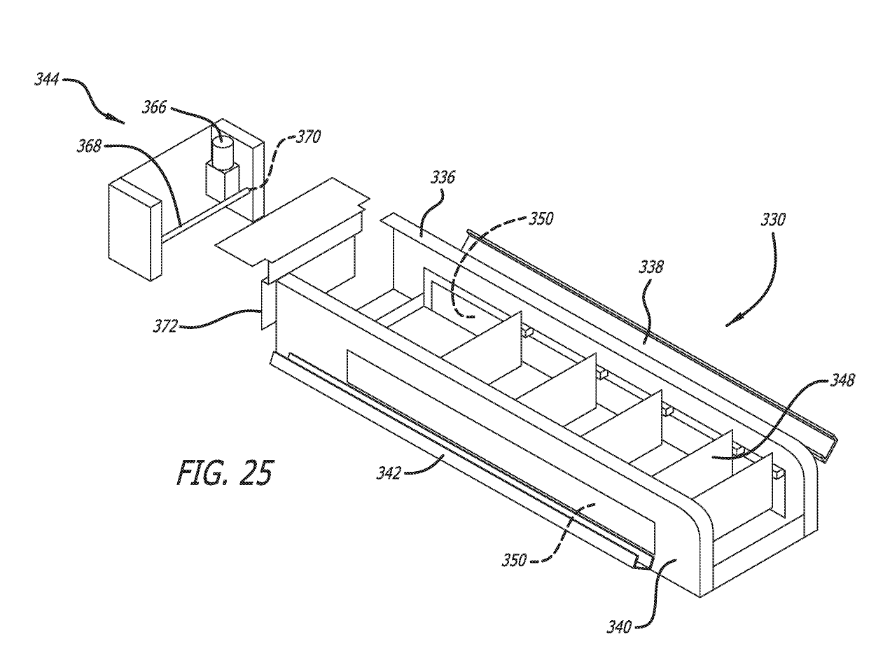

With reference to FIGS. 24 and 25, the motor and gears assembly 344 includes the tray's motor 366, the main shaft 368 rotatably connected to the motor, turning gears 370 connected to the main shaft, the tray's control board or tray's PCB 372 and the tray's power and data cord 374 (see FIG. 22). When the motor is turning, the turning gears maneuver the belts 346 forward on each side of the tray base 332. As a result, the compartments 354 are moved forward as well. When the compartments move forward, the flaps 362, 364 of the divider assembly 348 push the product toward the front of the tray. Flaps 362, 364 are inserted into and pivoting on the two side holders 358 and are held with springs 365. The design of the divider assembly 348, and in particular the main joist 356, prevents the flaps 362, 364 from folding backward. Therefore, the flaps are sufficiently sturdy to push the products in the compartment 354 forward.

Multiple compartments 354 can be created over the product platform 334 of each assembled tray. A single product can be placed inside each one of these compartments 354. When a product is situated inside a compartment 354, the sensors on PCB 350 detect the existence of the product. When the product is removed from the compartment, the sensors detect the product's removal. This detection is electronically reported to the backbone operating system or system management network which processes this information accordingly and uses it to conduct sales and reports. The connection between one or multiple numbers of product display assembly systems 330 and the backbone operating system can be over physical wires or via a wireless connection through cellular, WiFi and all other types of internet connectivity.

When a radio frequency detection system is used, an identification tag is attached to each product. RF close-proximity signal monitoring sensors and readers are installed onto the PCBs 350 and are programmed to detect the signal from the ID tags of each product and to report such detection to the backbone operating system or system management network. When a product is situated in the compartment 354, its tag is detected and the backbone operating system considers that product to be an existing item. When the product is removed from the compartment, its tag is no longer detected and the backbone operating system considers that product as a non-existing item. This detection is electronically reported to the backbone operating system, which processes this information accordingly and uses it to conduct sales and reports.

When a mechanical detection system is used, the insertion of a product into a compartment 354 triggers mechanical part movement that activates a tact-switch (not shown). When the product is removed from the compartment 354, the mechanical movement is reversed and the tact-switch is deactivated. This detection is electronically reported to the backbone operating system, which processes this information accordingly and uses it to conduct sales and reports.

When optical detection is used, optical emitters are installed onto the PCB 350 of one smart divider 336, 340, and optical receivers are installed onto the PCB of the other smart divider. Typically the emitters would be an IR-type emitter, as previously described. In such a case, the receivers on the PCB may also be IR receivers to match. Alternatively, other types of optical emitters and receivers can be used, such as laser or the like.

When the PCBs are installed onto their respective smart dividers 336, 340, the emitters and the receivers on the PCBs are contained within a small built-in cell, recessed behind the circular apertures 353. The fixed positions of the emitters and the receivers provides a pairing relationship between the emitters on smart divider 336 and the receivers on smart divider 340, or vice-versa. Furthermore, their fixed positions secure a restricted line of sight between each emitter and its paired receiver.

Following the creation of the compartments 354, the backbone operating system or system management network can select which emitters and receivers to activate, according to the compartments' setup and the type of the products within each compartment. One or more emitters or receivers may be associated with each compartment. Such selection may be done manually or automatically. When a compartment is empty, each activated emitter shines direct light and each paired receiver detects that light. When the compartment is not empty or filled, the product obstructs the line of sight and the receiver does not detect the emitted light.

After the backbone operating system is turned on, the association of emitters and receivers is performed, and the compartments are filled, the MT 330 is ready for operation. When a product is removed from a compartment 354, the assigned receiver(s) associated with the position of the compartment detects the light from the opposite emitter(s). Such detection is electronically reported to the backbone operating system, which processes this information accordingly and uses it to conduct sales or reports.

Following a sale completion, or removal of a product from the front-most compartment 354, the backbone operating system activates the motor 366 which maneuvers the belts 346 until the next filled compartment 354 reaches the front position. The backbone operating system stops the motor when the succeeding horizontal divider assembly 348 reaches and activates a limit switch (not shown).

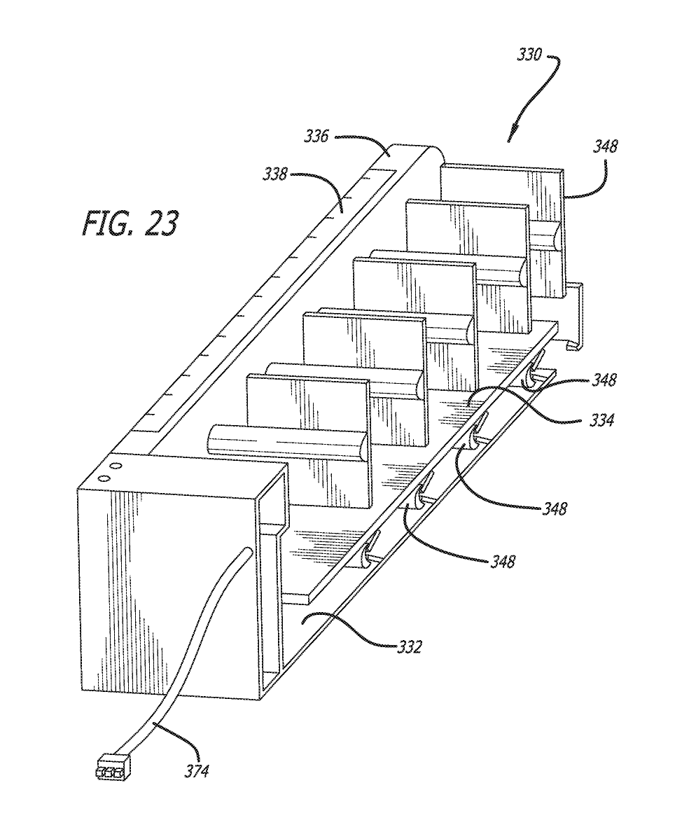

With reference to FIGS. 23 and 25-28, when each horizontal divider assembly 348 passes the MT's 330 front-end, the divider assembly begins to travel down the product platform 334, pulled by the belt 346, which persistently travels within the built-in tracks of smart dividers 336 and 340. The unique design of the tracks and the two side holders 358 allows the divider assembly 348 to keep its forward orientation even when it is traveling down the product platform. When the bottom flap 364 reaches the bulge over the surface of the base 332, its bottom is forced up and the flap 364 folds frontward. When the movement is continued and the top flap's 362 back surface contacts the product platform's 334 front edge, it is also forced to fold forward. After the movement continues, the divider assembly 348 and the two folded flaps 362, 364 maintain their forward orientation or retracted configuration and travel under the product platform 334. When each divider assembly 348 reaches the end of its travel under the product platform 334, the springs 365 force the top flap 362 to open while the divider assembly 348 is traveling up. At that time, the bottom flap 364 opens due to gravity, and the divider assembly 348 has returned to its extended configuration.

This arrangement and configuration allows the flaps 362, 364 to fold forward but to maintain their forward orientation throughout the entire circular loop around the product platform 334. Additionally, this unique function allows the divider assembly 348 and the folded flaps to travel within a very small space, between the base 332 and the product platform 334.

The benefits of such design are very significant. The folding method of flaps 362, 364, while keeping the forward orientation when they travel under the product platform 334, allows for reduction of the total height of the tray 330 and provides significantly more open space within the shelving setup.

Referring now to FIGS. 31-33, in a fifth embodiment of the present invention, which is a variation of the second embodiment previously described, a product display assembly system or spring pusher tray (SPT) 430 is provided which incorporates a built-in sensor system, and a pusher mechanism or element with spring. The SPT 430 can be used to display certain types of products which can sustain the constant pressure of the spring, such as glass-bottles or cans of drinks or other products with durable packaging.

The built-in sensor system allows for the detection of the presence or the removal of products. The sensor and detection systems can be optical, electrical, or mechanical or can be a system that detects electromagnetic waves, including radio frequencies such as RFID, NFC, etc. The detection is electronically reported to the backbone operating system or system management network, which processes this information accordingly and uses it to conduct sales and reports.

The spring pusher tray 430 comprises a base 432, a right vertical divider assembly or smart divider 434 including a right side PCB (not shown) and a right side cover 436, a left side vertical divider assembly or smart divider 438 including a left side PCB (not shown) and a left side cover 440, a track or sliding rail 442, a pusher or pusher element 444, and a spring 446. As multiple SPTs 430 may be placed on one shelf, one side of the SPT may be shared by the adjacent SPT. Therefore, the smart dividers 434, 438 may be identical to each other with features that allow detection of products 448 from both sides of the smart dividers.

When a radio frequency detection system is used, an identification tag is attached to each product. RF close-proximity signal monitoring sensors and readers are installed onto the PCBs of each smart divider 434, 438. Such RF sensors and readers are programmed to detect the signal from the ID tags of each product and to report such detection to the backbone operating system. When a product is over the sliding rail 442, its tag is detected and the backbone operating system considers that product to be an existing item. When the product is removed from sliding rail 442, its tag is no longer detected and the backbone operating system considers that product as a non-existing item. This detection is electronically reported to the backbone operating system, which processes this information accordingly and uses it to conduct sales and reports.

When a mechanical detection system is used, the placement of a product onto the sliding rail 442, triggers mechanical parts movement that activates a tact-switch (not shown). When the product is removed from the sliding rail 442, the mechanical movement is reversed and the tact-switch is deactivated. This detection is electronically reported to the backbone operating system, which processes this information accordingly and uses it to conduct sales and reports.

When an optical detection system is used, optical emitters are installed onto the PCB of one smart divider 434, 438, and optical receivers are installed onto the PCB of the other smart divider facing the associated emitters. Typically, the emitters would be IR-type emitters and the receivers will also be IR receivers to match. Alternatively, other types of optical emitters and receivers can be used, such as laser or others.

When the PCBs are installed onto smart dividers 434, 438, the emitters and the receivers on the PCBs are placed inside a small built-in cell, recessed behind circular apertures (not shown). The fixed positions of the emitters and the receivers allows for a pairing relationship between the emitters on one smart divider 434, 438 and the receivers on the other smart divider. Furthermore, such fixed positions secure a restricted line of sight between each emitter and its paired receiver.

Following the creation of the SPT 430, the backbone operating system can select which emitters and receivers to activate, according to the type of the products that are placed on top the sliding rail 442. One or more emitters or receivers may be associated with each placed product. Such selection may be done manually or automatically.

When no products are placed over the sliding rail 442, the activated emitter(s) shines direct light and the paired receiver(s) detects that light. When a product is placed on top of the sliding rail 442, the product obstructs the line of sight of the emitter and the receiver does not detect the light.

After the backbone operating system is turned on, the association of emitters and receivers is completed, and products are placed on top of the sliding rail 442, the SPT 430 is ready for operation. When a product is removed from the sliding rail 442, the assigned receiver(s) detect the light from the opposite emitter(s). This detection is electronically reported to the backbone operating system, which processes this information accordingly and uses it to conduct sales or reports.

The product display tray systems previously described including the MT and the SPT can be used in many different retail setups and can provide vital business information and advantages. In certain setups, they may be used only to encourage sales by moving products to the front. In other setups, however, they can also be used to conduct sales and to allow for real-time remote inventory readings over wired or wireless connections.

When the product display tray systems including the MT and the SPT are used in the automated store outlet's setup, as described in pending U.S. patent application Ser. Nos. 13/912,006 and 14/321,573, they are integrated with the automated store outlet's operating system and operates according to its commands.

Although several embodiments have been described in detail for purposes of illustration, various modifications may be made without departing from the scope and spirit of the invention. For example, elements and features previously described with respect to one embodiment can be common to every embodiment. Additionally, the sensors referenced in all embodiments can be optical, electrical, or mechanical sensors, or detect electromagnetic frequencies, including radio frequencies, such as RFID, NFC and the like. Accordingly, it is not intended that the invention be limited, except as by the appended claims.

What is claimed is:

1. A product tray assembly system comprising:
a tray base including a front side and a back side;
one or more pairs of vertical divider assemblies received within the tray base, each pair of vertical divider assemblies forming a product row display area therebetween, each vertical divider assembly including one or more sensors disposed on opposite sides of the vertical divider assembly, the one or more sensors being configured to detect the presence of one or more products within the product row display area; and
a controller in communication with each vertical divider assembly, the controller being configured to report detection of the presence of the one or more products by the one or more sensors in each vertical divider assembly to a system management network.

2. The product tray assembly system of claim 1, wherein the detection of the presence of the one or more products by the one or more sensors is reported to the system management network in the monitoring of sales and inventory.

3. The product tray assembly system of claim 1, wherein the one or more pairs of vertical divider assemblies are configured to be selectively received within the tray base at different distances from each other to accommodate the display of different sized products within each product row display area.

4. The product tray assembly system of claim 1, wherein the one or more pairs of vertical divider assemblies include a cover enclosing the one or more sensors.

5. The product tray assembly system of claim 1, wherein each vertical divider assembly includes a divider PCB, the one or more sensors being disposed on opposite sides of the divider PCB, wherein the one or more sensors of each vertical divider assembly include emitters of light on one side of the divider PCB and receivers of light on an opposite side of the divider PCB, the emitters and receivers being positioned such that each individual emitter of a first vertical divider assembly of the pair of vertical divider assemblies is individually facing and aligned with each individual receiver of a second vertical divider assembly of the pair of vertical divider assemblies, and wherein the presence of the one or more products is detected in response to obstruction by the one or more products of light from the emitters into the receivers.

6. The product tray assembly system of claim 5, wherein the emitters and receivers are infrared.

7. The product tray assembly system of claim 5, wherein each vertical divider assembly includes apertures correspondingly aligned with the emitters on the one side of the divider PCB and the receivers on the opposing side of the divider PCB to allow passage of light through the apertures.

8. The product tray assembly system of claim 1, further comprising one or more PCB boxes disposed at the back side of the tray base, the controller including one or more tray PCBs contained within the one or more PCB boxes.

9. The product tray assembly system of claim 1, further comprising one or more horizontal dividers placed between the one or more pairs of vertical divider assemblies and creating one or more compartments in the product row display area.

10. The product tray assembly system of claim 9, wherein the one or more horizontal dividers include fasteners connected to left and right sides of the one or more horizontal divider assemblies which are configured to selectively mate with corresponding fasteners in the pair of vertical divider assemblies.

11. The product tray assembly system of claim 10, wherein the one or more horizontal dividers include projections extending from the left and right sides which are configured to be selectively received in recesses integrated into each pair of vertical divider assemblies.

12. The product tray assembly system of claim 11, wherein the recesses define areas aligned with the one or more sensors for displaying indicia identifying the one or more sensors.

13. The product tray assembly system of claim 1, wherein the pair of vertical divider assemblies include divider projections configured to be selectively received in corresponding tray recesses integrated into the front and back sides of the tray base.

14. The product tray assembly system of claim 1, further comprising a pusher mechanism placed between the pair of vertical divider assemblies for advancing products forward in the tray base.

15. The product tray assembly system of claim 14, wherein the pusher mechanism includes a track having grooves, a pusher configured to be slidably attached to the track for movement along the grooves, and a spring within the pusher.

16. The product tray assembly system of claim 14, wherein the track includes track projections on opposing ends of the track configured to be selectively received in corresponding tray recesses integrated into the front and back sides of the tray base.

17. The product tray assembly system of claim 1, wherein the presence of the one or more products in the product row display area is detected by the one or more sensors using one of optical, electrical, mechanical, or frequency detection.

18. The product tray assembly system of claim 1, wherein the product tray assembly system includes a ready mode in which selected emitters and receivers of the one or more sensors are activated to optically detect the presence of the one or more products, a fulfillment mode in which the selected emitters and receivers are deactivated to allow for fulfilment of the tray base, and a quarantine mode in which a portion of the selected emitters and receivers are deactivated for a predetermined time.

19. The product tray assembly system of claim 1, further comprising a motorized mechanism for advancing the one or more products towards the front side of the tray base along a product platform disposed between and supported by the pair of vertical divider assemblies, the product platform having a top surface configured to support the one or more products and a bottom surface.

20. The product tray assembly system of claim 19, further comprising one or more horizontal divider assemblies disposed along the product platform to create compartments along the product platform, the horizontal divider assemblies being configured to advance forward along the product platform in response to detection by the one or more sensors of removal of the one or more products from the product platform.

21. The product tray assembly system of claim 20, wherein the motorized mechanism includes one or more counting sensors attached to the pair of vertical divider assemblies, mounting support elements attached to the pair of vertical divider assemblies, a closed chain with chain links attached to each vertical divider assembly, a motor supported under the bottom surface of the product platform, a driving shaft rotatably connected to the motor, sprockets connected to the driving shaft and supported by the pair of vertical divider assemblies, a counting sensor unit, and a perforated wheel connected to the driving shaft which is configured to move through the counting sensor unit.

22. The product tray assembly system of claim 21, wherein the one or more horizontal divider assemblies include a divider base, anchor pillars connected to the divider base and configured to be inserted within the chain links attached to each vertical divider assembly, an upper bar configured to be manually extended away from the divider base, side wheels connected to the upper bar, and elastic bungees connecting the upper bar to the divider base.

23. The product tray assembly system of claim 22, wherein each vertical divider assembly includes a track disposed along a top surface of each vertical divider assembly configured to receive the side wheels of the one or more horizontal divider assemblies, and wherein the elastic bungees of the one or more horizontal divider assemblies are configured to force the upper bar onto the divider base after the side wheels have exited the track on top of each vertical divider assembly to allow the one or more horizontal divider assemblies to move underneath the product platform in a retracted configuration toward the back side of the tray base.

24. The product tray assembly system of claim 20, wherein the one or more horizontal divider assemblies include a main joist having opposing ends, a side holder connected to each opposing end of the main joist, a side pin connected to each side holder, a top flap connected to the main joist between the side holders, a bottom flap connected to the main joist between the side holders, and a spring connecting the main joist to each side holder, the top flap and bottom flap being configured in an extended configuration to push the one or more products along the product platform toward the front side of the tray base, and the top flap and bottom flap being configured to be forcibly folded towards each other to allow the one or more horizontal divider assemblies to move underneath the product platform in a retracted configuration toward the back side of the tray base.

25. The product tray assembly system of claim 24, wherein the motorized mechanism includes a motor and gears assembly including a motor, a main shaft rotatably connected to the motor, gears connected to the main shaft, and the controller, and belts including pin barrels configured to selectively receive the side pins of the one or more horizontal divider assemblies and to move the one or more horizontal divider assemblies forward along the product platform.

26. The product tray assembly system of claim 1, wherein the one or more sensors are configured to detect using radio frequency the presence of the one or more products in response to reading of RFID tags placed on the one or more products.

27. The product tray assembly system of claim 1, wherein the one or more sensors are configured to mechanically detect the presence of the one or more products in response to the triggering of a tact switch.

28. The product tray assembly system of claim 1, wherein the product tray assembly system is incorporated into an automated store outlet.

29. A product tray assembly system comprising:
a tray base including a front side and a back side;
one or more pairs of vertical divider assemblies received within the tray base, each pair of vertical divider assemblies forming a product row display area therebetween, each vertical divider assembly including one or more sensors disposed on opposite sides of the vertical divider assembly, the one or more sensors being configured to detect the presence of one or more products within the product row display area;
a pusher placed between the pair of vertical divider assemblies for advancing the one or more products forward in the tray base; and
a controller in communication with each vertical divider assembly, the controller being configured to report detection of the presence of the one or more products by the sensors in each vertical divider assembly to a system management network.

30. A product tray assembly system comprising:
a tray base including a front side and a back side;
one or more pairs of vertical divider assemblies received within the tray base, each pair of vertical divider assemblies forming a product row display area therebetween, each vertical divider assembly including one or more sensors disposed on opposite sides of the vertical divider assembly, the one or more sensors being configured to detect the presence of one or more products within the product row display area;
one or more horizontal dividers placed between the one or more pairs of vertical divider assemblies and creating one or more compartments in the product row display area;
a motor for advancing the one or more products towards the front side of the tray base along a product platform, the product platform being disposed between and supported by the pair of vertical divider assemblies and having a top surface configured to support the one or more products; and
a controller in communication with each vertical divider assembly, the controller being configured to report detection of the presence of the one or more products by the sensors in each vertical divider assembly to a system management network.
